(19) United States
(12) Patent Application Publication
(10) Pub. No.: US 2025/0272979 A1
(43) Pub. Date: Aug. 28, 2025

(54) An Aquarium Management System And A Computer Implemented Method Of Determining Quality Of An Aquatic Environment Thereof

(71) Applicant: Expert AI Enabling Limited, Kowloon (HK)

(72) Inventors: Chun Chung Chan, Kowloon (HK); Wing Wai Danial CHEUNG, Kowloon (HK)

(21) Appl. No.: 18/861,475

(22) PCT Filed: Aug. 4, 2022
(86) PCT No.: PCT/CN2022/110394

§ 371 Date: Oct. 29, 2024

(30) Foreign Application Priority Data
Jul. 11, 2022 (HK) 32022056561.0

(51) Int. Cl. G06V 20/50; A01K 61/85; A01K 61/90; A01K 63/04; G06T 7/00; G06V 10/70; G06V 20/40; G06V 40/10; G06V 40/20

(52) U.S. Cl. CPC G06V 20/50; A01K 61/85; A01K 61/90; A01K 63/045; A01K 63/047; G06T 7/0002; G06V 10/70; G06V 20/40; G06V 40/10; G06V 40/20

(57) ABSTRACT

The invention provides an aquarium management system and a method implementing thereof. The system includes a video module for capturing video data including a series of frames showing an aquatic environment containing one or more life forms; a sensing module for detecting one or more conditions of the aquatic environment; an identifying module for identifying, from one or more frames of the video data, one or more visual characteristics of the life forms; and an analysing module for analysing the detected one or more conditions of the aquatic environment and the identified one or more visual characteristics of the life forms thereby determining a quality of the aquatic environment.

### FIELD OF THE INVENTION

The invention relates to an aquarium management system and a computer-implemented method of determining quality of an aquatic environment of an aquarium. Particularly but not exclusively, the invention relates to an aquarium management system adapted to determine, and optionally, control quality of an aquatic environment of the aquarium based on artificial intelligent technologies.

### BACKGROUND OF THE INVENTION

Aquariums for providing artificial habitats for aquatic animals and plants are commonly known for both domestic and commercial applications. In most aquarium settings, an aquarium generally comprises a water-storing container in which fish and/or other aquatic animals and plants are kept, an air pump and a water-filter to create water circulation, and optionally, landscape decorations to enhance the visual appeal of the aquarium. An aquarium can be provided not only for leisure, but also for conserving or culturing aquatic animals, as well as for educational purposes.

It is known that most aquatic animals and plants are sensitive to the aquatic environment where they are kept, and that their wellbeing is highly susceptible to changes in the environment such as water temperature and water quality. Any imbalance of the ecology may adversely affect the health and growth of the aquatic life forms therein, or may even endanger lives of the aquatic animals and plants.

However, the maintaining of an aquarium to provide a suitable environment for the kept aquatic organisms is often complicated and is also time and labor consuming. In addition to the regular cleaning of the aquarium settings and feeding of the aquatic animals, various skills and experiences of the keeper are generally required to manage the ecology in an aquarium. Different approaches are therefore adopted by the aquarium keepers to maintain and monitor the ecological conditions of the aquarium. For example, one may keep a schedule to regularly and visually check color of the water in the tank in order to monitor the quality of water. Other devices or tools such as pH papers may also be used to determine the pH and thus to estimate the level of waste in the water, which can be caused by excrements and/or unconsumed food of the aquatic animals. Monitoring systems have also been developed, such as devices to automate processes of feeding and/or water filtering, for example. Nonetheless, more effective and efficient systems for automatically managing ecology of the aquatic environment of aquariums are desirable.

### OBJECTS OF THE INVENTION

An object of the present invention is to provide a novel aquarium management system capable of determining a quality of the aquatic environment.

Another object of the present invention is to provide a novel aquarium system capable of determining, and optionally, controlling and managing a quality of the aquatic environment.

Another object of the present invention is to provide a computer-implemented method of determining, and optionally, controlling and managing a quality of an aquatic environment of an aquarium system.

A further object of the present invention is to mitigate or obviate to some degree one or more problems associated with known aquariums, or at least to provide a useful alternative.

The above objects are met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides an aquarium management system. The aquarium management system comprises a video module for capturing video data comprising a series of frames showing an aquatic environment containing one or more life forms; a sensing module for detecting one or more conditions of the aquatic environment; an identifying module for identifying, from one or more frames of the video data, one or more visual characteristics of the life forms; and an analysing module for analysing the detected one or more conditions of the aquatic environment and the identified one or more visual characteristics of the life forms thereby determining a quality of the aquatic environment.

In a second main aspect, the invention provides a computer implemented method of determining a quality of an aquatic environment of an aquarium system. The method comprises the steps of capturing, by a video module, a video data comprising a series of frames showing the aquatic environment containing the one or more life forms; detecting, by a sensing module, one or more conditions of the aquatic environment; identifying, by an identifying module, one or more visual characteristics of the life forms from one or more frames of the video data; and analysing, by an analysing module, the detected one or more conditions of the aquatic environment and the identified one or more visual characteristics of the life forms thereby determining a quality of the aquatic environment.

In a third main aspect, the invention provides a non-transistory computer readable medium storing machine-readable instructions which, when implemented on a processor, implements the steps of the method of the second main aspect.

In a fourth main aspect, the invention provides an aquarium management system comprising a memory for storing data and a processor for executing computer readable instructions, wherein the processor is configured by the computer readable instructions when being executed to implement the method of the second main aspect.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 is a schematic diagram showing an aquarium provided with an aquarium management system according to an embodiment of the present invention;

FIG. 2 is a block diagram of the aquarium management system of FIG. 1; and

FIG. 3 is a flow diagram showing a computer-implemented method of determining a quality of an aquatic environment of the aquarium system of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It should be understood that the elements shown in the figure, may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

The present invention relates to an aquarium management system and a computer-implemented method thereof for determining, managing and optionally, controlling a quality of an aquatic environment. Particularly but not exclusively, the aquarium system of the present invention is adapted to determine, in near real-time, quality of the aquatic environment and thus, an inferred suitability of the environment for living by aquatic life forms based on a combined sensing of one or more conditions of the aquatic environment, and determining of one or more behavioral patterns of the life forms in the aquatic environment based on visual characteristics of the life forms detected and analyzed using artificial intelligent (AI) technologies. The present invention therefore allows provision of a smart aquarium setting which offers a near real-time monitoring and managing of the quality of the aquatic environment and thus, maintaining a suitable ecology for living by the aquatic lives. The present invention may further control, adjust and/or modify various factors of the aquatic environment automatically in response to the quality of the aquatic environment detected. Users may choose to receive reports on the detected quality in the form of an alert signal which can be transmitted to various computer devices, including but are not limited to, portable mobile devices such as smart phones and smart watches, computer devices such as desk-top and lap-top computers, and/or general or customized alarm systems, according to the specific applications. The present invention provides an automated aquarium management system for an efficient, effective and reliable control and maintenance on the aquatic environment for improving wellbeing of the life forms being kept.

Referring to FIG. 1, shown is an aquarium 10 provided with an embodiment of the aquarium management system 100 of the present invention. The aquarium 10 may generally comprise a tank 2 which stores water for keeping aquatic animals and plants such as fish and water grasses. The aquarium 10 can be equipped with a number of devices or equipment for maintaining conditions of the aquarium 10 such as, but are not limited to, a lighting device 3 such as a light-emitting diode (LED) lighting, a water pump 4, and a filtering device 5, etc. Other parts and components of the aquarium management system 100 will be discussed further below.

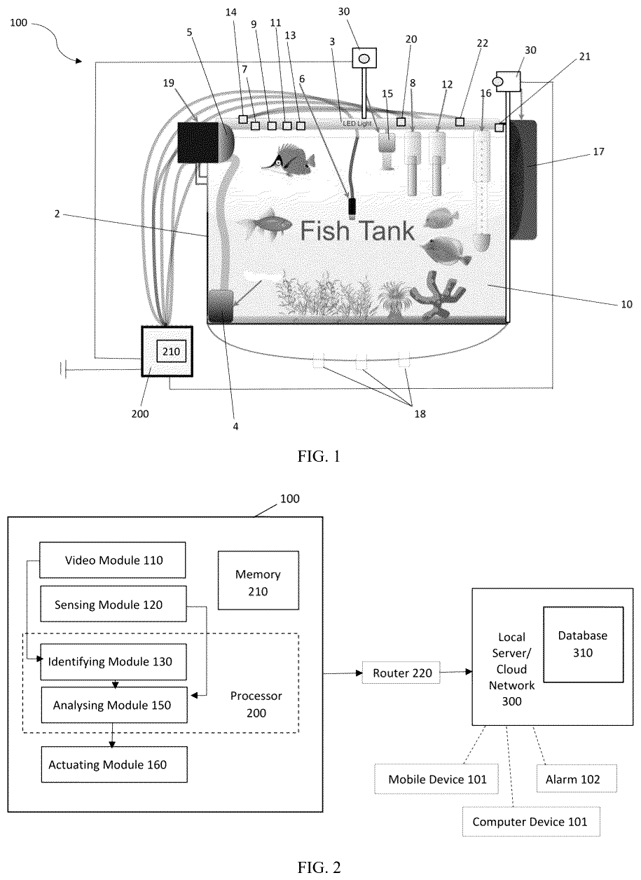

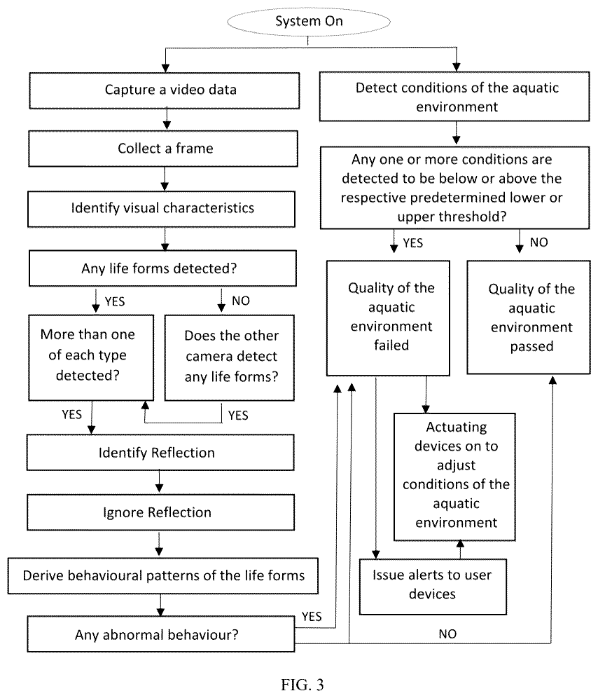

FIG. 2 shows a block diagram of the aquarium management system 100 according to an embodiment of the present invention. FIG. 3 further shows the method steps for determining a quality of the aquatic environment by the system 100.

The system 100 can be connected to one or more computer processing devices 101 such as but not limited to a smart phone, a tablet computer, a laptop computer, a personal computer (PC), or the like, although any suitable data or signal processing device or system may be utilized. The system 100 may also be connected to any general or customized alarm system 102, for generating a visual and/or an audible alert to the users. The computer processing devices 101 and/or the alarm system 102 are provided for the user to receive reports from the system 100 and/or alert signals if an unsatisfactory quality of the aquatic environment of the aquarium 10 is detected by the system 100. In one embodiment, the system 100 can be configured to connect with the computer processing devices 101 and/or the alarm system 102 via a communication network, which may include a router 220, to a local server 300 and/or a remote database such as a cloud database 300 or the like for transmitting and for storing data. In one further embodiment, the communication network may comprise a wireless network, e.g. a wireless cellular network, a wired network, the internet or any combination of the foregoing.

The system 100 may comprise a plurality of functional blocks for performing various functions thereof. In the illustrated embodiment, the system 100 comprises a video module 110 for capturing video data. The video data may comprise one or more videos comprising a series of frames showing an aquatic environment at the aquarium 10 containing one or more life forms. The life forms may comprise aquatic micro-organisms, animals such as fish, and/or plants such as water grasses. In one embodiment, the video module 110 may comprise one or more video cameras 30, and preferably, two or more video cameras 30 arranged to capture videos of the aquatic environment from different directions for an all-rounded, three-dimensional capturing of the life forms living therein.

The system 100 may further comprise a sensing module 120 for detecting one or more conditions of the aquatic environment. In one embodiment, the sensing module 120 may comprise one or more sensing devices comprising internet-of-things (IoT) devices such as, but are not limited to, one or more of a temperature sensor 6, a color sensor 7, a pH sensor 8, a chemical sensor 9 such as an ammonia sensor 9, a turbidity sensor 11, a conductivity sensor 12, a pressure sensor 13, a sensor for dissolved oxygen 14, a water level sensor 15, and a leak sensor 18, etc. The sensing module 120 is adapted to detect one or more conditions of the aquatic environment, which may include, but are not limited to, temperature, pH, ammonia level, color of water, turbidity of water, conductivity of water, pressure of water, oxygen level, etc. For example, one or more of the color sensor 7 and the turbidity sensor 11 can be used to detect development of colors at the water of the aquarium 10, which may attribute to any unwanted overgrowing if algae or bacterial, or unconsumed food due to overfeeding. The water level sensor 15 can be used to determine water level in the tank 2 to ensure that a suitable amount of water is provided at the aquarium 10. The pH sensor 8 can be used to monitor pH of the water, as any fluctuation of pH values may impose stress to the aquatic animals and plants, and reduce their resistance to diseases. The chemical sensor 9 such as the ammonia sensor 9 can be used to determine the waste level at the water, which may be caused by excrements of the animal, unconsumed food, and/or rotten plants. The temperature sensor 6 can be used to measure water temperatures of the aquarium 10. The water pressure sensor 13 can be used to determine whether the pump rate of the water pump 5 and thus the flow rate of water is adequate. The conductivity sensor 12 can be used to measure electrical conductivity (EC) of the water of the aquarium 10. The EC reading is important to provide an assessment on the concentration of dissolved ions, as different aquatic animals are known to preferably live in water of different, optimum EC values. For an aquarium where several types of aquatic animals are kept, a range of suitable EC values is preferred to be maintained to ensure the ionic condition suits all and every animal. A change in the EC value may reflect the presence of excess impurities in the water.

After detection of the various conditions of the aquatic environment by the sensor module 120, the detection data will be transmitted to the analyzing module 150, which may comprise or be provided as a component at a processor 200 which processes software including artificial intelligent (AI)-based software. The AI-based software may process any input data, such as the detection data from the sensor module 120, and/or stored data based on any previous detection. The previous data can be stored at a memory 210 and/or a database 310 located at the local server 300 and/or the remote cloud network 300. The AI-based software may include, but is not limited to, one or more machine learning and/or data analytic programs or algorithms. In one embodiment, if it is detected by the sensing module 120 that any one or more conditions of the aquatic environment fall out of the predetermined, optimum ranges set for the respective sensors, such as below a predetermined lower threshold or above a predetermined upper threshold, the relevant data will be processed by the software and the processed results will be reported to the users. Corresponding one or more actions may also be implemented by an actuating module 160 to adjust, modify or rectify the unsatisfactory conditions.

The system 100 may further comprise an identifying module 130 for identifying, from one or more collected frames of the captured video data, one or more visual characteristics of the life forms in the aquarium 10. Similar to the analyzing module 150, the identifying module 130 may comprise or be provided as a component at a processor 200 which processes artificial intelligent (AI)-based software. In one embodiment, the one or more visual characteristics of the life forms may comprise one or more of a size, a color, a shape, a texture, a position, an orientation and/or a location of the life forms as shown in the one or more collected frames of the video data. The identification or extraction of visual characteristics of the life forms can be processed by using artificial intelligent-based software which may include, but not limited to, any known computer vision programs or algorithms. The computer vision algorithms may process any input video data, such as those captured by the video module 110, and/or any previous data stored in the memory 210 and/or the database 310 located at the local server 300 or the remote cloud network 300. By processing the data identified based on the computer vision algorithms, one or more aquatic animals can be individually identified and located. In case if multiple life forms are detected, the computer vision algorithms may further identity possible reflection from the life form to avoid confusion of detection. The identified reflection of the same life form will be ignored and features of the same will not be processed further.

The identifying module 130 may preferably derive, based on the one or more identified visual characteristics, one or more behavioral patterns of the detected life forms. For example, the behavioral patterns of the life forms may include one or more of the following actions: air gulping, staying at water surface, staying at bottom of the tank of the aquarium, not eating, erratic swimming, swimming upside down, accelerating or decelerating, jumping out of water, lacking of energy, spasming, nipping at other life forms in the tank, wobbly swimming, slow to react to stimuli, rubbing against other items and/or other life forms in the tank. The identifying module 130 will then transmit the detected data including the visual characteristics and/or the derived behavioral patterns to the analyzing module 150, which processes artificial intelligent-based software based on the detected data and/or the stored, previous data to determine any abnormality in the derived behavioral patterns. Behavioral patterns which are found to deviate from the standard or normal behavioral patterns as learnt from the previous data and/or the user's preset instructions will be further processed by the analyzing module 150 and be reported to the user.

The analyzing module 150 will then analyze the one or more conditions of the aquatic environment detected by the sensing module 120, and the one or more visual characteristics and/or behavioral patterns of the life forms identified by the identifying module 130, to determine a quality of the aquatic environment and thus a suitability for living by the life forms. Preferably, the analysing module 150 analyses the detected one or more conditions of the aquatic environment and the identified one or more visual characteristics of the life forms further based on the previous data stored in the one or more databases 310 and, by processing the AI-based algorithm, the analysing module is adapted to continue learning from the received data from the sensing module 120 and/or the identifying module 130. For example, the database 310 can be configured to store one or more data such as the captured video data from the video module 110, the one or more visual characteristics of the life forms identified by the identifying module 130, the one or more conditions of the aquatic environment detected by the sensing module 130, and/or the determined quality of the aquatic environment from the analyzing module 150. The data from the database 310 can be used to train the artificial intelligent algorithms, including one or more of the computer vision algorithms, the machine learning algorithms, and/or the data analytic algorithms, to further improve speed and accuracy of the system 100. The analyzing module 150 therefore analyses by correlating the detected conditions with the features and/or behaviors of the identified life forms to thereby evaluate if any changes occur at the aquatic environment and how the changes have impacted or may impact the ecology of the aquatic environment. Furthermore, based on the collected, previous data, the AI algorithms may further suggest adjustments or modifications to the detected conditions if the determined quality of the aquatic environment deviates from the suggested or preset level. The adjustment or modification can be actioned manually by the user, after the user has received the report or alert signal from the system 100, or alternatively, be implemented automatically by the actuating module 160 of the system 100.

For as long as the system 100 is switched on, the detected and analyzed data will continually be streamed to and stored at the databases 310 at the local and/or cloud server 300. Individual life forms at the aquarium 10 will be identified and their locations at any time instant will be determined. The relevant behavioral patterns of the life forms will also be derived and assessed for abnormality. The behavioral patterns will be processed and correlated with the detected condition data from the sensing module 120 in view of any preset instructions and/or past data collected. Also, the locations detected can be used to compute relevant parameters such as speed, acceleration, and/or direction of movement of the life forms and these parameters can be useful in determining health conditions of the life forms by comparing the current data with past data using machine learning techniques over different time-periods. If some of the life forms are detected to be in unsatisfactory or unhealthy conditions, the information will be readily reported to the user. Based on the video data collected from the video module 110 and the sensing module 120 over time, the system 100 is able to determine if the correlation between the aquatic environment and the life forms is unsatisfactory or becoming unsatisfactory, so that appropriate actions can be taken timely or in advance to resolve, prevent and/or rectify the conditions.

While the sensing module 120 are used to detect various conditions of the water in the aquarium 10, the AI-based software of the system 100 may further assist in monitoring operation of the sensing module 120, and particularly, to continue adjusting and optimizing the predetermined ranges of detection data set for the various sensing devices. Instead of assessing a particular aspect of water condition, the data analytics and machine learning algorithms are implemented to evaluate an overall environment condition of the aquatic environment. From the continuous learning based on current and past data, the system 100 can be configured to predict any possible deviations in parameters of the aquatic conditions in the future. For example, if any condition data measured from the sensing module 120 shows deviations from the predetermined, optimum ranges, potential, possible issues with the aquatic environment can be predicted and alerts can be provided to the user in advance. For example, alert signals in the form of beeping alerts, text messages and/or email messages can be sent to the user's mobile phones and/or computer devices 101. The computer devices 101 may further be used to access the data saved in the local and/or remote database 310, and/or to control or adjust settings of the video module 110, sensing module 120 and/or the actuating module 160 via developed computer platforms and/or mobile applications.

Preferably, the actuating module 160 is adapted to automatically adjust or modify the one or more conditions of the aquatic environment in response to the quality of the aquatic environment determined by the analysing module 150. In one embodiment, the actuating module 160 may comprise one or more of a feeding device 19, a lighting device 3, a cooling device 17, a heating device 16, a water level controller 20, a water pump 5, a chemical dispenser 21, a filter 5 and/or a timer 22. One or more of these actuating devices can be used to alter to the detected conditions of the aquatic environment, with the adjustment or modification being conducted manually by the user and/or automatically by the system 100.

A person skilled in the art will appreciate that the present invention should not be limited to the specific embodiments as described and illustrated. For example, the skilled person will understand that the video module 110, the sensing module 120 and the actuating module 160 may comprise other internet-of-things devices or type of devices, as long as the devices operate to perform the functions as claimed for the respective modules.

The present invention provides an aquarium management system for controlling and maintaining the aquatic environment of an aquarium so as to improve wellbeing of the life forms therein. Particularly but not exclusively, the system of the present invention is adapted to determine, in near real-time, quality of the aquatic environment and thus suitability of the environment for living by the aquatic life forms. The system operates by implementing a combined sensing of one or more conditions of the aquatic environment, and determining of one or more behavioral patterns of the life forms in the aquatic environment based on visual characteristics of the life forms detected and analyzed using artificial intelligent (AI) technologies. Based on the data acquired real-time and the past data collected, the present invention allows predictions on any possible issues at the aquatic environment such that adjustment, modification or rectification can be actioned at early stage.

Apart from determining the quality of the aquatic environment of the aquarium, the AI algorithms may operate to further derive or determine information relating to the aquatic environment of the aquarium and the life forms living therein. The information may include, but is not limited to:
How much does each aquatic animal swim during a 24-hour period?
Is there a time during the day that the animal is more active or less active?
Is the active period of each animal the same?
Do some animals swim more often than the others? If so, how much more?
Which one is the most active or the least active animal?
Do some animals swim faster than the others? Which one is the fastest or the slowest swimmers?
How fast can each animal accelerate or decelerate?
Can an animal swim in a constant speed during a period of time? If so, how long can the animal maintain swimming at the constant speed?
How does an aquatic animal sleep?
Do all aquatic animals sleep by moving or not moving their bodies?
Do some animals sleep more often than the others?
Is the speed of movement an indication of sleeping patterns of an aquatic animal?
Do all fish swim backward?
How often do fish turn around in opposite directions?
Is it possible for aquatic animals to bump into each other?
Is there any relationship between the size of a fish and the speed they swim or how much they swim?
Is there any relationship between the activities of the aquatic animals and the temperature of the water?
Are there preferred locations within a tank for each animal?
Do some animals eat more than the others? If so, how much more?

The information may be useful for education and/or research purposes.

The computer system 100 may further comprise a memory 21 for storing machine-readable instructions. The computer system 100 may also include a processor 22 which is configured to execute the machine-readable instructions to thereby implement the methods of the invention as more fully described below. The memory storing machine-readable instructions and the processor for executing said machine-readable instructions together embody the system 100. It will be understood that the system 100 may comprise a plurality of components connected to the local server and/or network 300 for implementing the methods of the invention. It will also be understood that the system 100 can be embodied in any suitable computer device 110 by downloading suitable software to said computer device 110. Although the video module 110, the sensing module 120, the identifying module 130, the analysing module 150 and/or the actuating module 160 are shown as being deployed as functional components of the system 100, there is no limitation to such a deployment configuration according to the concepts of the invention. For example, one or more of these modules may be deployed as respective functional blocks that is distinct from, but connected to, the system 100. One or more of the modules can be separately implemented using logic circuits and/or executable code/machine readable instructions stored in a memory 210 of the system 100 for execution by a processor 200 to thereby perform functions as described herein. For example, the executable code/machine readable instructions may be stored in one or more memories 210, e.g. random access memory (RAM), read only memory (ROM), flash memory, magnetic memory, optical memory or the like, suitable for storing one or more instruction sets, e.g. application software, firmware, operating system, applets, and/or the like, data, e.g. configuration parameters, operating parameters and/or thresholds, collected data, processed data, and/or the like, etc. The one or more memories 210 may comprise processor-readable memories for use with respect to one or more processors 200 operable to execute code segments of any one or more of the functional modules as described above, and/or to utilize data provided thereby to perform functions of the system 100 as described herein. Additionally, or alternatively, one or more of the modules described may comprise one or more special purpose processors, e.g. application specific integrated circuit (ASIC), field programmable gate array (FPGA), graphics processing unit (GPU), and/or the like configured to perform functions of the system 100 as described herein.

In one aspect of the present invention, it is provided a non-transistory computer readable medium storing machine-readable instructions which, when implemented on a processor, implements the steps of the method as above described.

In one further aspect of the present invention, it is provided an aquarium management system comprising a memory for storing data and a processor for executing computer readable instructions, wherein the processor is configured by the computer readable instructions when being executed to implement the method as above described.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. An aquarium management system, comprising:
a video module for capturing video data comprising a series of frames showing an aquatic environment containing one or more life forms;
a sensing module for detecting one or more conditions of the aquatic environment;
an identifying module for identifying, from one or more frames of the video data, one or more visual characteristics of the life forms; and
an analysing module for analysing the detected one or more conditions of the aquatic environment and the identified one or more visual characteristics of the life forms thereby determining a quality of the aquatic environment.

2. The aquarium management system according to claim 1, wherein the one or more visual characteristics of the life forms comprise one or more of a size, a color, a shape, a texture, a position, an orientation and/or a location of the life forms as shown in the one or more frames of the video data.

3. The aquarium management system according to claim 1, wherein the identifying module is adapted to derive one or more behavioural pattern of the life forms based on the one or more identified visual characteristics of the life forms.

4. The aquarium management system according to claim 3, wherein the one or more behavioural patterns of the life forms comprise one or more of the following actions:
air gulping, staying at water surface, staying at bottom of a tank of the aquarium, not eating, erratic swimming, swimming upside down, accelerating or decelerating, jumping out of water, lacking of energy, spasming, nipping at other life forms in the tank, wobbly swimming, slow to react to stimuli, rubbing against other items and/or other life forms in the tank.

5. The aquarium management system according to claim 1, wherein the sensing module comprises one or more of a temperature sensor, a color sensor, a pH sensor, a chemical sensor, a turbidity sensor, a conductivity sensor, a pressure sensor, a sensor for dissolved oxygen, a water level sensor, and a leak sensor.

6. The aquarium management system according to claim 1, wherein the one or more conditions of the aquatic environment comprise one or more of a temperature, a pH, ammonia level, a color of water, turbidity of water, conductivity of water, pressure of water, oxygen level.

7. The aquarium management system according to claim 1, wherein the video module
comprises one or more video cameras.

8. The aquarium management system according to claim 7, wherein the one or more video cameras comprise two video cameras arranged to capture videos from different directions.

9. The aquarium management system according to claim 1, further comprising one or more databases for storing one or more of the following data: the captured video data, the identified one or more visual characteristics of the life forms, the detected one or more conditions of the aquatic environment, and/or the determined quality of the aquatic environment.

10. The aquarium management system according to claim 9, wherein the identifying module is adapted to process a computer implemented algorithm, the algorithm comprising one or more computer vision algorithms.

11. The aquarium management system according to claim 10, wherein the identifying module identifies the one or more visual characteristics of the life forms from the one or more frames of the video data based on the data stored in the one or more databases.

12. The aquarium management system according to claim 9, wherein the analysing module is adapted to processing a computer implemented algorithm, the algorithm comprising one or more of a machine learning algorithm and/or a data analytic algorithm.

13. The aquarium management system according to claim 12, wherein the analysing module analyses the detected one or more conditions of the aquatic environment and the identified one or more visual characteristics of the life forms based on the data stored in the one or more databases.

14. The aquarium management system according to claim 1, further comprising an actuating module adapted to automatically adjust or modify the one or more conditions of the aquatic environment in response to the quality of the aquatic environment determined by the analysing module.

15. The aquarium management system according to claim 14, wherein the actuating module comprises one or more of a feeding device, a lighting device, a cooling device, a heating device, a water level controller, a water pump, a chemical dispenser a filter and/or a timer.

16. The aquarium management system according to claim 1, wherein the one or more life forms comprise aquatic micro-organisms, animals and/or plants.

17. A computer implemented method of determining a quality of an aquatic environment of an aquarium system, comprising the steps of:
capturing, by a video module, a video data comprising a series of frames showing the aquatic environment containing the one or more life forms;
detecting, by a sensing module, one or more conditions of the aquatic environment;
identifying, by an identifying module, one or more visual characteristics of the life forms from one or more frames of the video data; and
analysing, by an analysing module, the detected one or more conditions of the aquatic environment and the identified one or more visual characteristics of the life forms thereby determining a quality of the aquatic environment.

18. The computer implemented method according to claim 17, wherein the one or more visual characteristics of the life forms comprise one or more of a size, a color, a shape, a texture, a position, an orientation and/or a location of the life forms as shown in the one or more frames of the video data.

19. The computer implemented method according to claim 17, further comprising the step of deriving one or more behavioural pattern of the life forms based on the one or more identified visual characteristics of the life forms.

20. The computer implemented method according to claim 19, wherein the one or more behavioural patterns of the life form comprise one or more of the following actions: air gulping, staying at water surface, staying at bottom of a tank of the aquarium, not eating, erratic swimming, swimming upside down, accelerating or decelerating, jumping out of water, lacking of energy, spasming, nipping at other life forms in the tank, wobbly swimming, slow to react to stimuli, rubbing against other items and/or other life forms in the tank.

21. The computer implemented method according to claim 17, wherein the sensing module comprises one or more of a temperature sensor, a color sensor, a pH meter, a chemical sensor, a turbidity sensor, a conductivity sensor, a pressure sensor, a sensor for dissolved oxygen, a water level sensor, and a leak sensor.

22. The computer implemented method according to claim 17, wherein the one or more conditions of the aquatic environment comprise one or more of a temperature, a pH, ammonia level, a color of water, turbidity of water, conductivity of water, pressure of water, oxygen level.

23. The computer implemented method according to claim 17, wherein the step of capturing a video data comprises capturing one or more videos via one or more video cameras.

24. The computer implemented method according to claim 17, further comprising the step of storing, in one or more database, one or more of the following data: the captured video data, the identified one or more visual characteristics of the life forms, the detected one or more conditions of the aquatic environment, and/or the determined quality of the aquatic environment.

25. The computer implemented method according to claim 24, wherein the step of identifying one or more visual characteristics of the life forms from one or more frames of the video data further comprises processing a computer implemented algorithm, the algorithm comprising one or more computer vision algorithms.

26. The computer implemented method according to claim 25, wherein the step of processing a computer implemented algorithm comprising one or more computer vision algorithms comprising processing with the data stored in the one or more databases.

27. The computer implemented method according to claim 24, wherein the step of analysing the detected one or more conditions of the aquatic environment and the identified one or more visual characteristics of the life forms further comprises processing a computer implemented algorithm, the algorithm comprising one or more of a machine learning algorithm and/or a data analytic algorithm.

28. The computer implemented method according to claim 27, wherein the step of processing a computer implemented algorithm comprising one or more of a machine learning algorithm and/or a data analytic algorithm comprising processing with the data stored in the one or more databases.

29. The computer implemented method according to claim 17, further comprising receiving instruction by an actuating module from the analysing module to thereby automatically adjust or modify the one or more conditions of the aquatic environment in response to the quality of the aquatic environment determined by the analysing module.

30. The computer implemented method according to claim 29, wherein the actuating module comprises one or more of a feeding device, a lighting device, a cooling device, a heating device, a water level controller, a water pump, a chemical dispenser, a filter and/or a timer.

31. A non-transitory computer readable medium storing machine-readable instructions
which, when implemented on a processor, implements the steps of the method of claim 17.

32. An aquarium management system comprising a memory for storing data and a processor for executing computer readable instructions, wherein the processor is configured by the computer readable instructions when being executed to implement the method of claim 17.
